(19) United States
(12) Patent Application Publication
(10) Pub. No.: US 2014/0000163 A1
(43) Pub. Date: Jan. 2, 2014

(54) WATER CULTURE HYDROPONICS SYSTEM

(71) Applicant: Ming-Tsun Lin, Zhubei City (TW)

(72) Inventor: Ming-Tsun Lin, Zhubei City (TW)

(21) Appl. No.: 13/539,750

(22) Filed: Jul. 2, 2012

(51) Int. Cl. A01G 31/02

(52) U.S. Cl. 47/62 R

(57) ABSTRACT

A water culture hydroponics system of the invention is mainly disposed with a box body. At least one vertical plane of the box body is disposed with a plurality of openings for placing plants. At least one water pipe is disposed onto an inner side of the box body. The surface of the water pipe is disposed with a plurality of water spraying holes such that fluid within the water pipe is sprayed toward the plants from each water spraying hole. An exterior of the box body is disposed with at least one lamp wall for providing lateral light source to the plants to allow the inside of the box body to achieve optimum uniform moisture effect, and in conjunction with the irradiation of light beam, an effect of culturing and growing plants can be facilitated.

### BACKGROUND OF THE INVENTION

1. Field of the Invention

The present invention generally relates to a water culture hydroponics system, in particular to a water culture hydroponics system that allows the inside of the box body to achieve optimum uniform moisture effect, thereby facilitating the effect of culturing and growing plants.

2. Description of the Related Art

To maintain the normal growth of plants, oxygen, water content and inorganic nutrients must be supplied to root-zone environment. A conventional plant cultivation manner is to supply nutrients through “soil”. In another word, seeds or offspring is planted in soil and regularly applied with fertilizer and irrigated with water. These plants are performed with photosynthesis through carbon dioxide within air and sunshine, thereby achieving the growth. Afterward soilless culture which takes soil-free as the culture medium is developed. The foregoing technique must artificially provide the culture medium and nutrient solution to complete the purpose of growing plants. Therefore, the technique is so called “nutriculture”.

The conventional nutriculture usually uses sponges to fasten plants. Roots of these plants are always immersed the nutrient solution. Therefore, this culture manner is also called hydroponic culture. The culture must resupply air (oxygen) into the nutrient solution (for example, oxygen can be injected by the nutrient solution or delivered by a pump) to retain the respiration required for the root that is immersed in the nutrient solution.

In addition, since land resources are limited, population still increases. Utilizing limited lands to increase enough food for feeding mankind has become one of important topics researched by scientists. A research of improving genes of plants is mainly to allow the plant to reach the maximum production in the shortest time to provide the greatest contribution for mankind. However, in this research, experiments must be continuously performed, and a plant growing box can be one of important tools. Its enclosed space is utilized to culture plants, and temperature and humidity of the box then are controlled to obtain the optimum conditions for growing plants. Therefore, controlling related variables is a critical issue.

### SUMMARY OF THE INVENTION

Therefore, it is a primary objective of the present invention to provide a water culture hydroponics system that allows the inside of the box body to achieve optimum uniform moisture effect, thereby facilitating the effect of culturing and growing plants.

To achieve the foregoing objective, a water culture hydroponics system of the invention is mainly disposed with a box body. At least one vertical plane of the box body is disposed with a plurality of openings for placing plants. At least one water pipe is disposed onto an inner side of the box body. The surface of the water pipe is disposed with a plurality of water spraying holes such that fluid within the water pipe is sprayed toward the plants from each water spraying hole. An exterior of the box body is disposed with at least one lamp wall for providing lateral light source to the plants to allow the inside of the box body to achieve optimum uniform moisture effect, and in conjunction with the irradiation of light beam, an effect of culturing and growing plants can be facilitated.

The water culture hydroponics system of the invention has the following advantages:

1. The inside of the box body can achieve optimum uniform moisture effect to facilitate the efficacy of growing and culturing plants.

2. Water usage can be reduced by providing water content through the hydroponic manner.

3. Water content can be provided through the hydroponic manner to provide gas required for plants, thereby strengthening the growth of plants.

The box body can be vertically placed and provides culture to plants to achieve effects of the saving and adequately utilizing the placing space and enhancing decoration and beauty.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a stereogram of a structure of a water culture hydroponics system of the present invention;

FIG. 2 is an exploded diagram of a structure of a water culture hydroponics system of the present invention;

FIG. 3 is a stereogram of another structure of a water culture hydroponics system of the present invention; and

FIG. 4 is a stereogram of further structure of a water culture hydroponics system of the present invention.

### DETAILED DESCRIPTION OF THE PREFERRED EMBODIMENTS

The technical content of the present invention will become apparent by the detailed description of the following embodiments and the illustration of related drawings as follows.

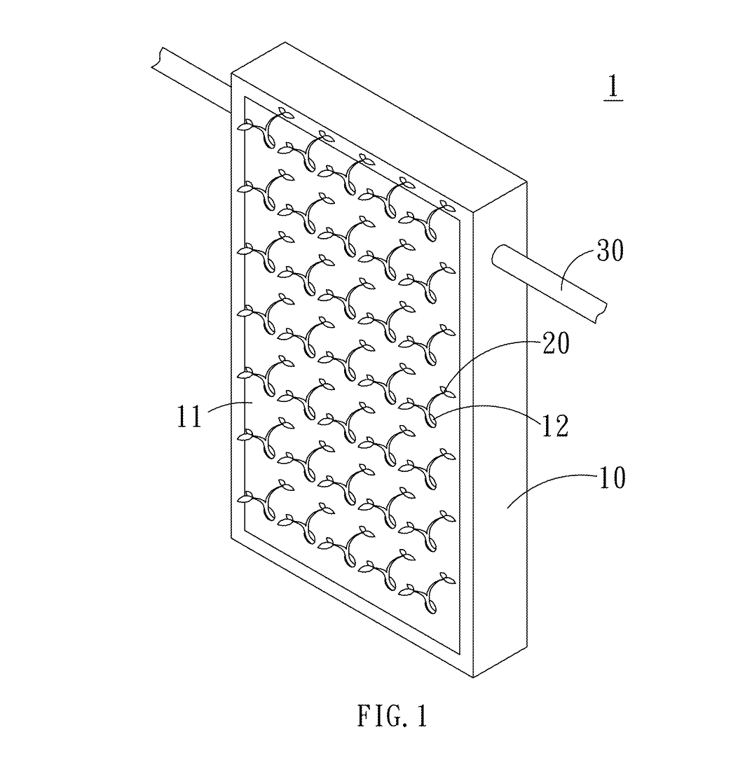

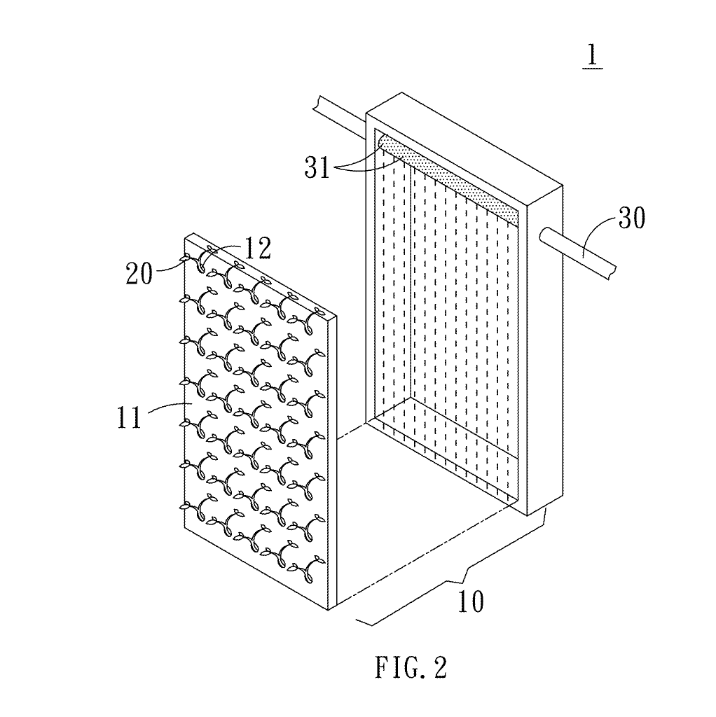

With reference to FIG. 1 for a stereogram of a structure of a water culture hydroponics system according to the invention and FIG. 2 for an exploded drawing of a structure of a water culture hydroponics system according to the invention are depicted. The water culture hydroponics system 1 is mainly disposed with a box body 10. At least one vertical plane 11 of the box body 10 is disposed with a plurality of opening 12 for placing plants 20. At least one water pipe 30 is disposed to the upper portion at the inner side of the box body 10. The surface of the water pipe 30 is disposed with a plurality of water spraying holes 31.

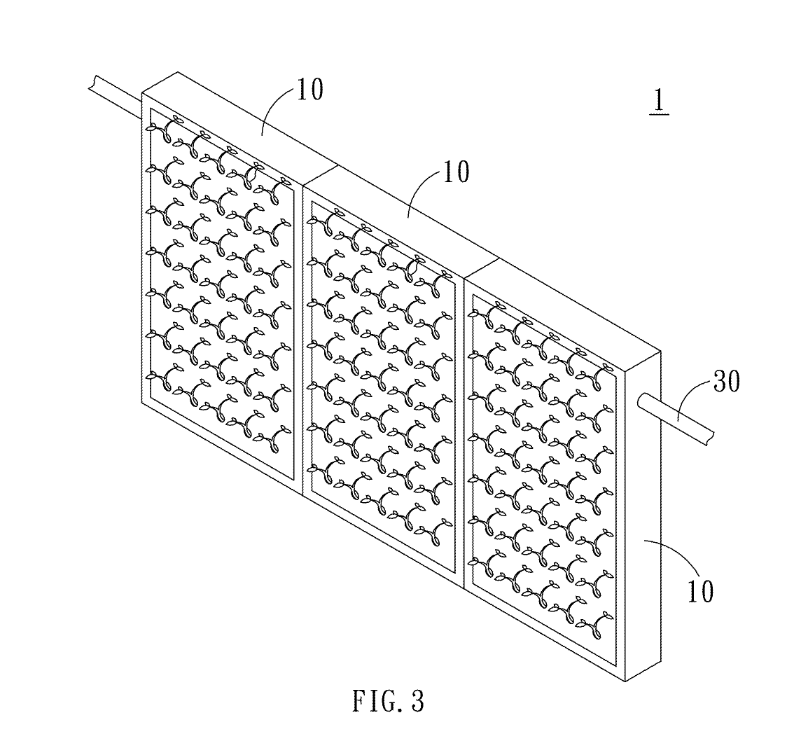

While in use, each plant 20 is placed and fastened onto the vertical plane 11 of the box body from each opening 12 to form a vertical culturing wall. Fluid within the water pipe 30 can be sprayed toward the plant 20 from the water spraying hole 31 to form an effect of shower type fluid supply to allow the inside of the box body 10 achieving optimum uniform moisture effect, thereby facilitating the effect of culturing and growing plants. Of course, fluid inside the water pipe can contain nutrient solution to provide nutrition required for plants. In addition, a plurality of box bodies 10 can also be cascaded to each other as shown in FIG. 3.

A lamp wall is also disposed to an exterior of the box body to provide lateral light source and vertical light beam, especially for controlling the illumination condition of plants. Further, plants to be cultured can be cultured by adopting a manner of straight arrangement to achieve the purpose of effectively utilizing floor space. The lamp wall can disposed with at least one lamp board. The lamp board can be parallel the box body. Alternatively, the lamp board can be obliquely disposed to an outside of the box body to provide the illumination condition required for plants.

Moreover, the box body is further disposed with a gas circulation component. The gas circulation component is disposed with at least a gas inlet, a gas outlet and a gas sucking member. The gas inlet and the gas outlet are disposed onto the box body. The gas sucking member sucks outside gas into the box body from the gas inlet and extracts gas inside the box body away from the gas outlet to form a gas circulation. The gas circulation can incorporate with the shower type fluid supply to allow shower type fluid encapsulating gas so as to provide gas (e.g. oxygen) required for plants.

In addition, the bottom of the box body is further disposed with a water receiving tray for receiving liquid dropped from the water spraying holes, and a side of the water receiving tray is disposed with a water pumping component. The water pumping component is disposed with a motor and a water pumping pipe. The water pumping pipe at another side of the water pumping component is connected to the water pipe. Liquid accumulated in the water receiving tray can be pumped to the water pumping pipe through the motor and then is introduced to the water pipe for repeat use. The water pumping component can be further disposed with a timer. The timer is connected to the motor such that a user can freely set time of turning on/off the motor.

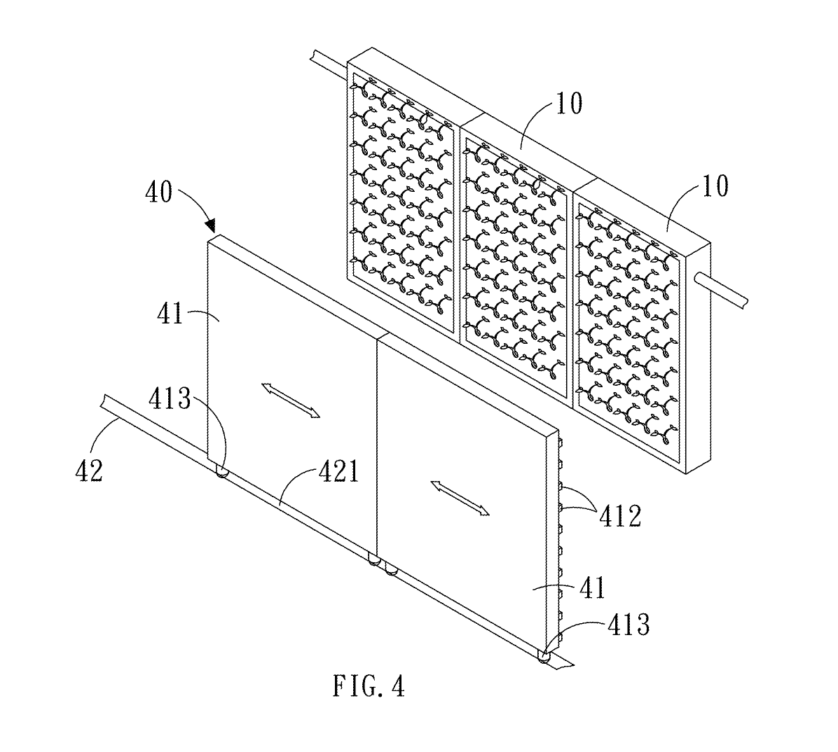

Moreover, the lamp board 41 of the lamp wall 40 is to construct at least one light emitting element 412 on a board member as shown in FIG. 4. The lamp wall is further disposed with a base 42. The main body of the base 42 is disposed with at least one first inserting slot 421 arranged along the base 42. At least one side of the board member of the lamp board 41 is disposed with a sliding mechanism 413 provided for joining the first inserting slot 421. As shown in the embodiment of the figure, the sliding mechanism 413 can be pulley. Alternatively, the first inserting slot is T-shaped cross section. The sliding mechanism of each lamp board is the T-shaped cross section structure capable of being correspondingly joined to each first inserting slot.

The lamp board 41 can be stably installed on the base 42 by utilizing a simple inserting manner, and the base 42 can be selected to laterally extend and dispose with number of lamp boards 41 based upon actual using demand. Of course, under the use condition, a user can also quickly regulate the lateral position of the lamp board 41 by means of simply pushing the lamp board 41.

The lamp wall can further include at least one engagement base (not shown in the figure) and have at least two lamp boards. At least two corresponding sides of the board member of each lamp board are respectively disposed with a sliding mechanism provided for joining the first inserting slot of the base. A plurality of second inserting slots arranged along the axis direction of the engagement base and joined with the sliding mechanism of each lamp board is disposed on its main body of the engagement base. Several layers of lamp boards are upwardly extended and arranged through number of engagement bases according to actual use demand. Each first inserting slot and each second inserting slot are T-shaped cross-section. The sliding mechanism of each lamp board is the T-shaped cross section capable of being correspondingly inserted and joined with each first inserting slot and each inserting slot.

The lamp wall can also be further disposed with the fastening base. The fitting portion of each fastening base is disposed with at least one screw through hole. The position of the base joined with each fastening base is respectively and circularly disposed with a plurality of screw holes provided for aligning at least one screw through hole such that the fastening base is combined with the base by utilizing screws.

By utilizing the foregoing structural features, other screw holes are aligned with screw through holes on the fastening base through the rotation of the base, and the purpose of easily regulating angles of the lamp board can be achieved by means of locking screws into the screw holes.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A water culture hydroponics system mainly disposed with a box body, at least one vertical plane of the box body disposed with a plurality of openings provided for placing plants, at least one water pipe disposed on an inner side of the box body, a surface of the water pipe disposed with a plurality of water spraying holes so that liquid within the water pipe is sprayed toward the plants from each water spraying hole, an exterior of the box body disposed with at least one lamp wall for providing a lateral light source to each plant.

2. The water culture hydroponics system of claim 1, wherein a bottom of the box body is further disposed with a water receiving tray for receiving liquid dropped from each water spraying hole.

3. The water culture hydroponics system of claim 2, wherein a side of the water receiving tray is disposed with a water pumping component, and another side of the water pumping component is connected to the water pipe, and the water pumping component is disposed with a motor and a water pumping pipe.

4. The water culture hydroponics system of claim 3, wherein the water pumping component is disposed with a timer and the timer is connected to the motor.

5. The water culture hydroponics system of claim 1, wherein the box body is further disposed with a gas circulation component, and the gas circulation component is disposed with at least one gas inlet, a gas outlet, and a gas sucking member, and the gas inlet and the gas outlet are disposed on the box body, and the gas sucking member introduces exterior gas into the box body through the gas inlet and sucks interior gas inside the box body through the gas outlet to form a gas circulation.

6. The water culture hydroponics system of claim 1, wherein the lamp wall is disposed with at least one lamp board, and the lamp board is parallel the box body, and the lamp board is obliquely disposed to an outside of the box body.

7. The water culture hydroponics system of claim 6, wherein the lamp board is to construct at least one light emitting element on a board member, and the lamp wall is further disposed with a base, and a main body of the base is disposed with at least one first inserting slot axially arranged along the base, and at least one side of the board member of the lamp board is disposed with a sliding mechanism capable of joining the first inserting slot.

8. The water culture hydroponics system of claim 7, wherein the lamp wall is further disposed with at least one engagement base and two lamp boards; and at least two corresponding sides of the board member of each lamp board are respectively disposed with a sliding mechanism capable of being joining the first inserting slot of the base, and the main body of the engagement base is disposed with a plurality of second inserting slots axially arranged along the engagement base and capable of being joined with the sliding mechanism of each lamp board.

9. The water culture hydroponics system of claim 8, wherein each first inserting slot and each second inserting slot are T-shaped cross-section, and the sliding mechanism of each lamp board is the T-shaped cross section capable of being correspondingly inserted and joined with each first inserting slot and each second inserting slot.

10. The water culture hydroponics system of claim 7, wherein the lamp wall is further disposed with at least one fastening base fastened to the main body of the base, and the fastening base has a fitting portion joined with the base and a bottom provided for being stably in contact with the locking surface, and the fitting portion of the fastening base is disposed with at least one screw through hole, and a position of the base joined with the fastening base is respectively and circularly disposed with a plurality of screw holes provided for aligning at least one screw through hole such that the fastening base is combined with the base by utilizing screws
